(19) United States
(12) Patent Application Publication
(10) Pub. No.: US 2026/0277224 A1
(43) Pub. Date: Sep. 17, 2026

(54) CONTROLLING STABILITY OF MOBILE MANIPULATORS BY ADJUSTING THE CENTER OF MASS

(71) Applicant: ABB Schweiz AG, Baden (CH)

(72) Inventors: Arne-Christoph Hildebrandt, München (DE); Jonas Larsson, Västerås (SE); Christoph Bick, Augsburg (DE)

(73) Assignee: ABB Schweiz AG, Baden (CH)

(21) Appl. No.: 19/668,314

(22) Filed: May 5, 2026

Related U.S. Application Data
(63) Continuation of application No. PCT/EP2023/081093, filed on Nov. 8, 2023.

(51) Int. Cl. G05D 1/49; B25J 5/00

(52) U.S. Cl. CPC G05D 1/498; B25J 5/007

(57) ABSTRACT

A method for controlling a mobile manipulator includes determining a current configuration of the mobile manipulator including a manipulator arm configuration and a manipulator base configuration, determining a desired movement trajectory of the mobile manipulator, determining a current zero-movement points (ZMP) trajectory, determining a desired ZMP trajectory of the mobile manipulator, wherein each ZMP is located within a support polygon of the manipulator base, adjusting the mobile manipulator such that the current ZMP trajectory corresponds to the desired ZMP trajectory, wherein the step of adjusting the mobile manipulator comprises adjusting a center of mass of the mobile manipulator including an adjustment of the manipulator arm configuration.

### CROSS-REFERENCE TO RELATED APPLICATIONS

The instant application claims priority to International Patent Application No. PCT/EP2023/081093, filed Nov. 8, 2023, which is incorporated herein in its entirety by reference.

### FIELD OF THE DISCLOSURE

The present disclosure generally relates to a method for controlling a mobile manipulator, a mobile manipulator, a computer program product, and a computer-readable medium.

### BACKGROUND OF THE INVENTION

In recent years, automation industry is focusing more and more on automating applications in industries with limited space. These applications often consist of combinations of transportation tasks in laboratory environments and pick & place tasks on different workplaces. A robot type, which is proposed to answer these needs, is the mobile manipulator. It combines a mobile base with an attached manipulator. Due to limited space in laboratory environments, the requirements on the size of these robots are increasing. Especially the footprint size of the robot is in the focus for optimization. Common manipulators often comprise a heavy and large base, which may be disadvantageous when the robots should operate in constrained spaces. In addition to the size of the robot, the overall time the robot needs to execute tasks has to be constantly decreased. This need leads to higher acceleration of the mobile base while navigating and while executing pick and place tasks. A challenge that arises from these requirements is to ensure that the robot stays stable and, for instance, does not tip over. Problems at the stability may occur with higher dynamic forces which therefore increases the challenge to ensure the stability of the robot.

Thus, there is a need for sophisticated approaches to prevent an instability of a mobile manipulator.

### BRIEF SUMMARY OF THE INVENTION

The present disclosure relates to a method for controlling a mobile manipulator comprising a manipulator base and at least one manipulator arm. In one embodiment, the method includes determining a current configuration of the mobile manipulator including a manipulator arm configuration and a manipulator base configuration; determining a desired movement trajectory of the mobile manipulator; determining a current zero-movement points (ZMP) trajectory, comprising the location of one or more current ZMP of the mobile manipulator, based on the current configuration of the mobile manipulator and the desired movement trajectory; determining a desired ZMP trajectory of the mobile manipulator, wherein each ZMP is located within a support polygon of the manipulator base; adjusting the mobile manipulator such that the current ZMP trajectory corresponds to the desired ZMP trajectory.

In the method according to the present invention, the step of adjusting the mobile manipulator comprises the step of adjusting a center of mass of the mobile manipulator including an adjustment of the manipulator arm configuration.

Accordingly, an improved method for stabilizing mobile manipulators during the movement along a distinct path is provided, which ensures that the mobile manipulator may stay stable and does not tip over during the movement.

### BRIEF DESCRIPTION OF THE SEVERAL VIEWS OF THE DRAWING(S)

For a better understanding of the present invention, and to illustrate its practicality, figures are provided in the following and reference is made thereto. It should be understood that the figures represent only exemplary embodiments and thus in no way limit the scope of the claimed invention. Identical or like-acting elements are indicated throughout by the same reference signs. Any reference signs in the claims should not be construed as limiting the scope of the claims.

In the accompanying drawings,

FIGS. 1A and 1B schematically illustrate a mobile manipulator according to the present invention in different configurations;

FIG. 2 is a flowchart illustrating a method for controlling a mobile manipulator according to the present invention; and

FIG. 3 is a flowchart illustrating a method for controlling a mobile manipulator according to the present invention.

### DETAILED DESCRIPTION OF THE INVENTION

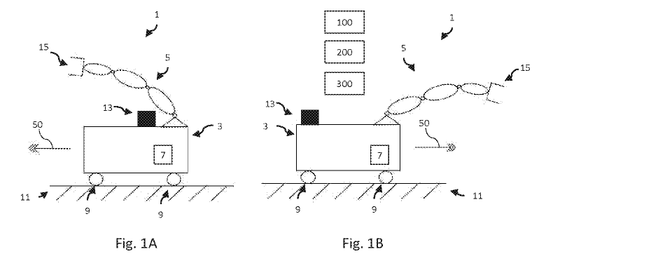

FIGS. 1A and 1B depict a mobile manipulator 1 according to the present invention. The mobile manipulator 1 comprises a manipulator base 3 and a manipulator arm 5 attached at the top side of mobile base 3. It will be understood that in different embodiments, also more than one manipulator arm 5 may be provided and that the position of the one or more manipulator arms 5 may vary, e.g. the manipulator arm 5 may be provided at the front or back side or at a lateral side of the of the mobile manipulator 1. The mobile manipulator arm 5 is formed as a movable arm comprising multiple arm elements which are linked together to allow a flexible movement and extension or retraction of the arm. However, it will be understood that in different environments also a stiff manipulator arm may be provided consisting for instance only of a single stiff-arm element movably attached to the manipulator base 3. The manipulator arm 5 is hinged at a proximal end of the manipulator arm 5 with the mobile phase 3 and comprises a tool center point, TCP, 15 at the distal end of the manipulator arm. In the depicted embodiment, the TCP 15 is formed as a gripper to allow a grip of an external item or load. The manipulator base 3 comprises contact elements 9 in form of wheels to contact the floor 11. Thus, the mobile manipulator 1 may be moved along the floor 11. During movement of the mobile manipulator 1, the manipulator arm 5 is essentially in a fixed condition. However, along the movement trajectory, different fixed arm positions may be provided. For instance, when the mobile manipulator 1 moves along a certain movement trajectory comprising multiple tracks, a distinct arm position may be assumed, as shown in FIG. 1A, at a first movement path section. A different distinct arm position, as shown in FIG. 1B, may be accordingly provided at a second first movement path section. In FIG. 1A, the mobile manipulator 1 moves towards the left side, as depicted by arrow 50. In FIG. 1B, the mobile manipulator one moves towards the right side, as depicted by arrow 50. The mobile manipulator 1 may be moved along a predefined movement trajectory.

The mobile manipulator 1 further comprises a mass element 13, arranged at the top surface of the manipulator base 3. However, in different embodiments of the present invention, no additional mass elements are provided. As shown, the mass element 13 can be located at different positions with respect to the manipulator base 3. For instance, as shown in FIG. 1A, the mass element 13 is arranged at the right side of the manipulator base 3, close to the proximal side of the manipulator arm 5 at which it is attached to the manipulator base 3. It will be understood that in different embodiments also more than one mass element 13 may be provided and that the position of the one or more mass elements 13 may vary. Further, as shown in FIG. 1B, the mass element 13 is arranged at the left side of the manipulator base 3, spaced from the proximal side of the manipulator arm 5 to counteract a shift of the center of mass by the depicted manipulator arm configuration. As shown in FIGS. 1A and 1B, the movable arm manipulator arm 5 may have different orientations with respect to the manipulator base 3.

The orientations of the manipulator arm 5 may be set and controlled by the control means 7 of the mobile manipulator. In the depicted embodiment, the control means 7 is arranged at the mobile manipulator 1. However, it will be understood that in different embodiments, the control means 7 can also be arranged at least partially outside of or remote from the mobile manipulator 1. The control means 7 may comprise suitable sensing, computing and controlling means for controlling the elements of the mobile manipulator 1, for instance an orientation of the manipulator arm 5 or a propelling speed, acceleration and direction of the wheels. Dependent on the configuration of the manipulator arm 5, the center of mass of the mobile manipulator 1 changes. For instance, due to the manipulator arm configuration, the center of mass of the mobile manipulator 1 of FIG. 1B is shifted more to the right compared to the center of mass of the manipulator 1 of FIG. 1A because the manipulator arm 5 in FIG. 1B extends further beyond and away from the manipulator base 3 compared to the configuration of FIG. 1A. As noted above, this is counteracted by the positioning of the mass element 13. In a different embodiment, a center of mass may be shifted by changing only a manipulator arm configuration, e.g. a position of the manipulator arm 5.

When the center of mass is shifted too far, the mobile manipulator 1 may be in an unstable condition such that a tipping of the mobile manipulator 1 may occur. This may be counteracted, for instance, by controlling the orientation of the manipulator arm 5 to one or more proper positions. Thus, when the mobile manipulator 1 moves along the predefined movement trajectory, for instance along different distinct paths of an industrial, scientific or medical site, the manipulator arm 5 may be controlled according to the present invention to assume different configurations to maintain stable condition during movement. This may include setting a first arm configuration at a first travel path or section and to set a different a second configuration at a second travel path or section.

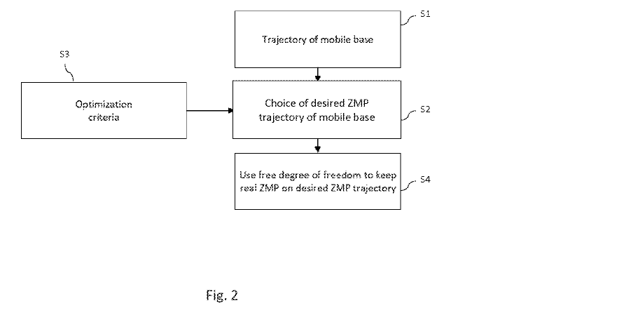

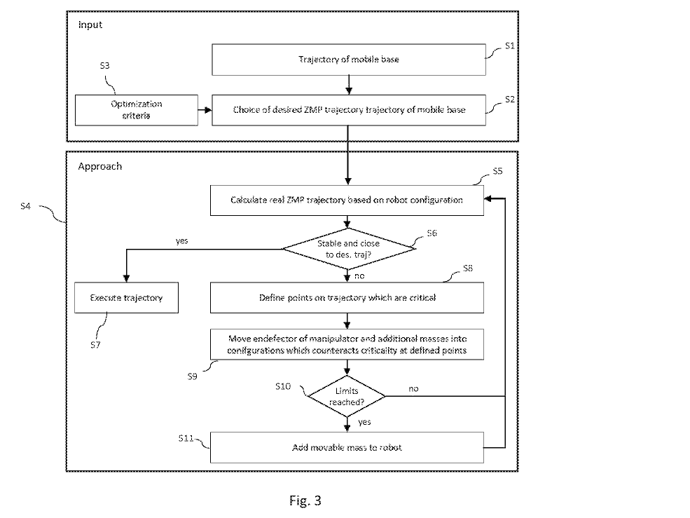

Further, a computer-program product 200 and a computer-readable medium 300 are shown, each comprising instructions, which, when executed by a computer 100, cause the computer 100 to carry out and/or control the method of any embodiments of the present invention, in particular the method as illustrated in FIGS. 2 and 3. In the depicted embodiment, the computer 100, the computer-program product 200 and the computer-readable medium 300 are depicted as external elements. However, it will be understood that in different embodiments, any of the computer 100, the computer-program product 200 and the computer-readable medium 300 may be at least partly integrated in the mobile manipulator 1.

FIG. 2 depicts a flowchart illustrating a method for controlling a mobile manipulator 1 according to an embodiment of the present invention. In step S1 of the depicted embodiment, a desired movement trajectory of the mobile base 3 or the mobile manipulator 1 is determined. In step S2 of the depicted embodiment, based on the desired movement trajectory, the desired ZMP trajectory of the mobile base 3 or the mobile manipulator 1 is chosen or determined. As shown in step S3, optimization criteria may be introduced to improve the overall performance of the mobile manipulator 1. Such optimization criteria may be any suitable criteria for optimizing a mobile manipulator action such as, for instance, the requirement to employ the lowest possible acceleration or the highest possible speed or to reduce the power consumption of the mobile manipulator 1. In step S4, which is explained in greater detail further below, the ZMP trajectory is used as input for the definition of the motion of the mobile manipulator 1 to exploit the redundant degrees of freedom. The free degrees of freedom can be accordingly used to keep the current ZMP trajectory of the mobile manipulator 1 on the desired ZMP trajectory of the mobile manipulator 1.

FIG. 3 depicts a flowchart illustrating a method for controlling a mobile manipulator 1 according to an embodiment of the present invention. As depicted, the steps S1 to S3 correspond to the steps S1 to S3 of FIG. 2, wherein the output of steps S1 to S3 form an input for the following steps. In FIG. 3 denoted as “approach”, the step S4 of FIG. 2 is explained in greater detail. Herein, the output of step S2 is used as an input for step S5, wherein in step S5 the current or real ZMP trajectory of the mobile manipulator 1 is determined or predicted. Based on that determination, it is determined or predicted in step S6, whether the current ZMP trajectory is a stable trajectory which corresponds or is close to the desired ZMP trajectory of the mobile base. If the answer is “yes”, the trajectory is executed in step S7. If the answer is “no”, points of the desired movement trajectory of the mobile manipulator 1 for which the ZMP do not correspond to the desired that ZMP trajectory are determined or predicted in step S8. In step S9, the end effector and/or a manipulator arm and/or additional masses may then be accordingly adjusted or moved such that their changed position counteracts the criticality regarding a tipping or instable movement of the mobile manipulator 1 at the defined points.

Thus, the center of mass of the mobile manipulator 1 is accordingly adjusted by the respective movement of the manipulator arm 5 to avoid an unstable condition of the mobile manipulator 1 at the calculated critical points. Subsequently, in step S10, it is determined or predicted whether the limits of a movement of the manipulator arm or the additional masses are reached. The answer is “no”, the method returns to step S5, wherein the current ZMP trajectory of the mobile manipulator 1 is determined or predicted based on the adjusted setting. If the answer is “yes”, further additional masses may be added to the mobile manipulator to overcome an instability. Then, the method returns to step S5, wherein the current ZMP trajectory of the mobile manipulator 1 is determined or predicted based on the adjusted setting.

It will be understood that the method according to the present invention is not limited to the above noted order of method steps. Quite to the contrary, the method steps may be also provided in a different order and one or more of the above noted method steps may be removed or further method steps may be added, as desired.

In the context of the present disclosure, the mobile manipulator may be understood as any kind of movable robot. “Mobile” or “movable” manipulators in this context may be understood such that the manipulator may assume different positions or locations on the ground. The position of the mobile manipulator may be accordingly changed. For instance, the mobile manipulator may move itself or is moved by respective means from a starting point to an end point via a predetermined distinct travel path.

The manipulator arm may be any type of mechanical arm. The manipulator arm may comprise multiple elements linked with each other and the mobile base to form a kinematic chain. The links of such a manipulator arm may be connected by respective joints allowing for instance a rotational motion or a linear translational displacement. However, it will be understood that the manipulator arm may also comprise only one stiff element linked to the manipulator base. The manipulator arm may be programmable for allowing execution of respective movements for performing different tasks. Also, more than one manipulator arm may be provided.

The manipulator base may essentially define the core body of the mobile manipulator, at which the manipulator arm is attached. The manipulator base may house respective propelling or controlling means such as the power supply, one or more motors and/or computing devices and may be enclosed by a housing to protect the mobile manipulator elements arranged inside from negative impacts, such as dust and moisture. The manipulator base may define the support polygon. The support polygon may be a surface area upon which the mobile manipulator is supported or carried on the ground. The support polygon may comprise three, four or more edges or may have a circular, oval or of any other two-dimensional shape.

The current configuration of the mobile manipulator may include information about the extension and/or the weight of the respective parts of the mobile manipulator. For instance, the current configuration may include information about a center of mass of each component and/or the whole mobile manipulator. The manipulator arm configuration may include an extension or orientation of the manipulator arm with respect to the manipulator base, e.g. an angle of rotation or an extension of the manipulator arm. The manipulator base configuration may include information about the manipulator bases’ weight or the dimensions of the manipulator base, such as, for instance, the dimension of a lower base surface of the manipulator base, which may form the support polygon. Any suitable parameter concerning the center of mass of the mobile manipulator may be included.

The location at which the manipulator arm is attached to the manipulator base may be fixed or may vary. The manipulator arm may be provided at any desired side of the manipulator base, for instance at a top side, a front or back side, or at one of the lateral sides of the mobile manipulator. The manipulator arm configuration may include a distinct position and/or orientation of the manipulator arm in space, such as an arm stance. The manipulator arm configuration may comprise an information about the rotational position of the manipulator arm or an extension of the manipulator arm, e.g. an extension beyond the manipulator base. The manipulator base configuration may accordingly comprise a spatial extension and a weight or weight distribution of the manipulator base.

The desired movement trajectory may be a trajectory or path the mobile manipulator may take on a ground. Thus, the desired movement trajectory may be provided in an essentially horizontal two-dimensional plane. The mobile manipulator may move on the ground along the desired movement trajectory from a start position to an intermediate or end-position. The desired movement trajectory may be based on one or more tasks the mobile manipulator should perform, e.g. to pick up an item at a first position and to place said item at a second position. The movement trajectory may comprise one or more straight movements or curved movements, or any other arbitrary geometrical movement on the ground between the start position and the end-position. The desired movement trajectory may comprise intermediate positions, at which the mobile manipulator may change its direction of motion. For instance, the mobile manipulator may pick up an item at a start position and move along the desired movement trajectory towards an end position to drop said item at this end position. The mobile manipulator may accordingly continue to a third point with or without picking up the same or a different item and/or may return to its starting position. The manipulator arm configuration may be essentially fixed or predetermined during the movement along certain sections of the desired movement trajectory.

A ZMP may be understood as a point at which reaction forces of a contact between mobile manipulator and the ground do not produce any moment in the horizontal direction, i.e. in a direction of a plane in which the mobile manipulator moves. This may be a direction in a plane essentially perpendicular to a direction of gravity. In a common notation, a plane in which the mobile manipulator moves may extend in a x-y-direction and the direction of gravity is in a z-direction. The ZMP may be considered as the point where the sum of horizontal moments M x, and M y is zero. In other words, the ZMP may be defined as the reference point in the contact plane between robot and ground, for which the horizontal components of the contact moment vanish. The ZMP of the mobile manipulator may depend on the manipulator arm configuration, the manipulator base configuration, e.g. the extension of the support polygon, and the desired movement trajectory. One or more ZMP may be determined or predicted for the mobile manipulator. A determination may also be understood as a prediction in the current disclosure. Any ZMP may depend on a configuration of the mobile base and the manipulator arm including, for instance, a weight and spatial extension of said components and their respective arrangement with respect to each other.

Based on the current configuration of the mobile manipulator, a current ZMP trajectory may be determined or predicted. The current ZMP trajectory may correspond to one or more predicted ZMP locations of the mobile manipulator when the mobile manipulator would move along the desired movement trajectory. The mobile manipulator may be considered stable when its predicted current ZMP are located within the support polygon. If the one or more predicted current ZMP of the mobile manipulator are arranged in the support polygon, the mobile manipulator may be stable such that no tipping over may occur during the movement along the desired movement trajectory. Thus, in the method of the present invention, the mobile manipulator may be preferably configured such that its ZMP are in the support polygon, thus allowing for a stable movement or standstill.

Accordingly, knowing the desired movement trajectory of the mobile manipulator and considering the mobile manipulators’ configuration, e.g. based on the arm configuration, a desired ZMP trajectory may be determined or predicted, which may allow for a stable movement of the mobile manipulator when moving along the desired movement trajectory. If the mobile manipulator would move along the desired movement trajectory, and its ZMP corresponds or is sufficiently close to the desired ZMP trajectory, stable movement of the mobile manipulator may be achieved.

Thus, the mobile manipulator may be accordingly adjusted such that the current ZMP trajectory may correspond or may be close to the desired ZMP trajectory to achieve a stable movement of the mobile manipulator. This adjustment may be performed before or during the movement of the mobile manipulator. For different sections of the movement trajectory, different adjustments of the mobile manipulator may be provided to obtain stable configuration.

For instance, if a ZMP would lie outside or is too far away from the desired ZMP trajectory, a mobile manipulator might accordingly become unstable during movement. Hence, a suitable adjustment of the mobile manipulator, e.g. regarding the manipulator arm, may be determined and performed. The manipulator arm may be, for instance, adjusted in its orientation or position from a first position to a second position, such that a center of mass, and accordingly the ZMP of the mobile manipulator, may be shifted towards a more central position of the mobile manipulator, thus providing an increased stability. The mobile manipulator may be accordingly adjusted such that it might be no longer unstable when it would move along the desired movement trajectory.

The center of mass may comprise the masses and dimensions of the whole mobile manipulator or may only comprise masses and dimensions of individual parts. This may be, for instance, the largest parts or parts, which have the largest impact on the position of the center of mass of the mobile manipulator.

In some examples, the adjustment of the mobile manipulator may include an adjustment of the manipulator arm, e.g. a certain rotation of the arm, to shift the center of mass. Or the adjustment of the mobile manipulator may include an adjustment of an extension or reach of the manipulator arm with respect to the manipulator base to avoid a tipping over of the mobile manipulator. Further adjustments may consider the addition, removal or change of position of weight associated with the mobile manipulator.

In a preferred embodiment, the method comprises the steps of determining critical points along the desired movement trajectory at which the mobile manipulator becomes unstable and adjusting the center of mass of the mobile manipulator to counteract the determined instability such that the mobile manipulator no longer becomes instable at the critical points.

Thus, an efficient and reliable method for providing a stable movement of the mobile manipulator may be achieved, which may be adapted to any desired movement of the mobile manipulator. Critical points may include points or locations along the movement trajectory, at which the center of mass may change due to, for instance, picking up additional weight or changing a stance of the mobile manipulator arm or may be points at which the mobile manipulator accelerates, breaks, or performs a change of direction. The adjustment of the center of mass may be accordingly sufficient to achieve stability of the mobile manipulator along at least parts of, preferably along the whole, movement trajectory, in particular at the critical points. The determination or prediction of critical points may also include also not only single points but also sections of the path or movement trajectory of the mobile manipulator for which the center of mass may be properly adjusted to allow a stable movement.

In a preferred embodiment, the manipulator base comprises one or more contact elements configured to contact a ground upon which the mobile manipulator is movable, wherein the contact elements preferably comprise one or more wheels.

Thus, a stable stand on the ground of the manipulator base during movement or standstill may be achieved. The manipulator base may comprise at least three contact elements. However, also a different number of contact elements may be provided. The support polygon may be accordingly defined by an area spanned between the contact elements contacting the ground. The ZMP may be accordingly adjusted to be located essentially in this contact area to allow a stable movement or stand of the mobile manipulator. Providing wheels may allow the mobile manipulator to be easily steered along the ground in one or more desired directions. One or more of the wheels may be actively steerable by respective controls and propelling means of the mobile manipulator or may rotate passively. The present invention is not limited to wheels but may also comprise any type of steerable or non-steerable element that may allow a movement of the mobile manipulator on the ground.

In a preferred embodiment, the step of determining the desired movement trajectory of the mobile manipulator includes a determination of a movement path of the mobile manipulator and/or a determination of an acceleration of the mobile manipulator.

Thus, one or more of the movement paths or the acceleration of the mobile manipulator may be considered for the adjustment of the mobile manipulator. The acceleration may be defined and known in advance over the whole path, which may facilitate the adjustment of the mobile manipulator to obtain stability. However, also different parameters may be considered in advance, such as the velocity, for instance the maximum velocity of the mobile manipulator, which may be considered known in advance. Each of the parameters may be, for instance, considered being fixed to a certain value, such as a minimum or maximum value.

In a preferred embodiment, the step of adjusting the center of mass of the mobile manipulator includes an adjustment of the configuration of the manipulator arm to one or more manipulator arm configurations, wherein the manipulator arm is preferably moved from one manipulator arm configuration to another manipulator arm configuration to adjust the center of mass of the mobile manipulator.

Thus, the center of mass of the mobile manipulator may be easily adjusted in stability, for instance, without the employment of further additional weights. The adjustment may include an iterative movement of the manipulator arm to one or more different positions. The adjustment may include moving the manipulator arm to one or more fixed arm configurations. For the adjustment, the movement trajectory or path of the mobile manipulator and the acceleration along said path may be known. A respective fixed arm configuration, which may be a pre-defined arm configuration for the whole path or for one or more sections of the path, may be considered for the determination or calculation of the ZMP of the mobile manipulator. The adjustment of the center of mass may be performed during a movement of the mobile manipulator or may be performed at a standstill of the mobile manipulator, for instance before the mobile manipulator starts to move or between two critical points. The movement of the arm may be preferably a slow movement to avoid dynamic force influences. The adjustment of the manipulator arm may be performed when the mobile manipulator is in a stable resting position, for instance before it begins to move along the movement trajectory.

In a preferred embodiment, the mobile manipulator comprises one or more variable mass elements, and the step of adjusting the center of mass of the mobile manipulator includes an adjustment of the variable mass elements.

Thus, the mobile manipulator could be adjusted in addition or alternatively to the adjustment of the arm configuration of the mobile manipulator, which may increase the flexibility, and which may extend the limits of the stabilizing adjustment. The variable mass elements may be positioned at different distinct positions the mobile manipulator to influence and adjust the center of mass of the mobile manipulator. The variable mass element may comprise a fixed weight or may have a variable weight, which may be adapted. The variable mass element may be a single mass element or may comprise multiple mass elements, which may be individually adjustable. Further, also a plurality of different weights may be provided depending on the need for adjustment of the mobile manipulator. The mass elements may be provided at any suitable position at the mobile manipulator, e.g. at an outer side of a housing, for instance at the top side or inside a housing the mobile manipulator. The mass elements may be adjusted manually by a user or automatically to one or more positions. The mass elements may be suitably adapted to the weight or dimensions of the mobile manipulator, for instance in a way that a proper stabilization of the mobile manipulator could be achieved while avoiding unnecessary weight.

In a preferred embodiment, the variable mass elements include one or more external mass elements that are removably arrangeable at the mobile manipulator and the step of adjusting the center of mass of the mobile manipulator includes adding or removing the external variable mass elements to the mobile manipulator. Additionally, or alternatively, the variable mass elements include one or more internal mass elements that are non-removably arrangeable at different positions at the mobile manipulator and the step of adjusting the center of mass of the mobile manipulator includes varying the positions of the internal variable mass elements.

Thus, a particular precise and efficient adjustment of the center of mass may be achieved.

An external mass element may be understood as a mass element that is not immediately associated with respect to the mobile manipulator but can be added or removed, as desired. As an example, a tool or grip arranged at a distal end of the manipulator arm, e.g. at a tool center point, may grip a weight to adjust the center of mass of the mobile manipulator. If the manipulator picks up a certain weight during his tasks, said additional weight may be accordingly considered for the adjustment of the center of mass. External mass elements may include any type of additional weights or masses, that could be conveniently added or removed manually or automatically with respect to the mobile manipulator.

Contrary to this, internal mass elements may be understood as mass elements which are more or less immediately associated with the mobile manipulator. This may include mass elements which may be fixedly or movably arranged or mounted inside or outside of a housing of the mobile manipulator. The internal mass elements may be, for instance, arranged on respective rails arranged at the mobile manipulator to allow a simple and defined positioning of said weights.

The movement of internal and external mass elements may be accordingly sensed and controlled by respective sensing and control means of the mobile manipulator. The positioning of the internal and external mass elements may be performed along any desired direction. The movement of the variable mass elements may be performed by moving the mass elements along one or more pre-defined movement trajectories with respect to the mobile manipulator. Also, a combination of external and internal mass elements may be provided and the adjustment of the center of mass of the mobile manipulator may be accordingly performed based on an individual or joint adjustment of the external and internal mass elements.

The invention further relates to a mobile manipulator, comprising a manipulator base and at least one manipulator arm, and a control means adapted to control the mobile manipulator in accordance with the method of the present disclosure.

It is noted that the above explanations regarding certain elements or advantages described with respect to the method of controlling a mobile manipulator of the present disclosure accordingly apply to the mobile manipulator described herein. Thus, a mobile manipulator, which is particularly stable during the movement, may be provided. The control means may be arranged at the mobile manipulator or at least partially outside and remote to the mobile manipulator. The control means may comprise suitable computing and controlling means for controlling any elements of the mobile manipulator, for instance an orientation or extension of the manipulator arm and/or a propelling speed, acceleration or a steering of the wheels. The control means may comprise respective sensors or detectors to determine a position or movement of the respective elements. The determination of any configuration of the mobile manipulator and/or the determination or prediction of any parameters, such as the current configuration of the mobile manipulator, the desired movement trajectory, the determination of the ZMP, the current or desired ZMP trajectory and so forth, may be performed by respective computational means, which may or may not be part of control means of the mobile manipulator. The mobile manipulator may comprise one or more tools arranged at the distal end of the manipulator arm to perform respective manipulating actions, such as for instance picking and lifting an item and transporting and placing said item at a different position.

In a preferred embodiment, the manipulator base comprises one or more contact elements configured to contact a ground upon which the mobile manipulator is movable, wherein the contact elements are preferably formed by wheels.

Thus, a mobile manipulator with a particular stable stand of the manipulator base on the ground during movement or standstill may be achieved.

In a preferred embodiment, the manipulator arm is adjustable to one or more manipulator arm configurations, wherein the manipulator arm is preferably movable from one manipulator arm configuration to another manipulator arm configuration to adjust the center of mass of the mobile manipulator.

Thus, the mobile manipulator may be easily adjusted with respect to stability by adjusting the center of mass, for instance, without further additional weights.

In a preferred embodiment, the mobile manipulator additionally comprises one or more variable mass elements that are adjustable to adjust the center of mass of the mobile manipulator.

Thus, a mobile manipulator may be provided, which could be adjusted in addition or alternatively to the adjustment of the configuration of the mobile manipulator, which increases the flexibility and extends the limits of the stabilizing adjustment.

In a preferred embodiment, the variable mass elements include one or more external mass elements that are removably arrangeable at the mobile manipulator to adjust the center of mass of the mobile manipulator. Additionally, or alternatively the variable mass elements include one or more internal mass elements that are non-removably arrangeable at different positions at the mobile manipulator to adjust the center of mass of the mobile manipulator.

Thus, a mobile manipulator may be provided for which a particular precise and efficient adjustment of the center of mass may be achieved.

In a preferred embodiment, the mobile manipulator is an autonomous mobile manipulation robot, preferably comprising more than two steerable wheels.

Thus, a flexible and reliably stabilizable autonomous mobile manipulation robot is provided. This may include any type of manipulation robot, such as a mobile manipulator which may be movable over the ground. The movement of the robot along the ground and the movement of the arm may be fully or semi-automatically controlled. At least more than two steerable wheels may allow for a particularly well controlled movement over the ground. The wheels may be jointly or independently propellable or steerable. The mobile manipulation robot may be an industrial robot, a logistic robot, a medical robot, a laboratory robot or any other kind of robot, working in a respective industrial, logistic, medical or laboratory environment, that may use one or more manipulation arms arranged on a movable manipulator base to execute the desired tasks.

The invention further relates to a computer-program product comprising instructions, which, when executed by a computer, cause the computer to carry out and/or control any of the methods of the present disclosure.

The features of the system according to the present invention may be implemented by respective suitable digital or computational means, which can include, for instance, one or more computers, apps and/or networks.

The method may be at least partly computer-implemented, and may be implemented in software or in hardware, or in software and hardware. Further, the method may be carried out by computer program instructions running on means that provide data processing functions.

The data processing means may be a suitable computing means, such as an electronic control module etc., which may also be a distributed computer system. The data processing means or the computer, respectively, may comprise one or more of a processor, a memory, a data interface, or the like.

The invention further relates to a computer-readable medium comprising instructions which, when executed by a computer, cause the computer to carry out and/or control any of the methods of the present disclosure.

Any of the computer, the computer-program product and/or the computer-readable medium may be at least part of the mobile manipulator or may be arranged remotely to the mobile manipulator.

A computer program may be stored/distributed on a suitable medium such as an optical storage medium or a solid-state medium, supplied together with or as part of other hardware, but may also be distributed in other forms, such as via the Internet or other wired or wireless telecommunication systems.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 mobile manipulator

3 manipulator base

5 manipulator arm

7 control means

9 contact elements

11 ground

13 mass elements

15 tool center point

50 movement of mobile base

100 computer

200 computer program product

300 computer readable medium

S1 to S11 method steps

What is claimed is:

1. A method for controlling a mobile manipulator comprising a manipulator base and at least one manipulator arm, the method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base; and
adjusting the mobile manipulator such that the current ZMP trajectory corresponds to the desired ZMP trajectory;
wherein adjusting the mobile manipulator comprises adjusting a center of mass of the mobile manipulator including an adjustment of the manipulator arm configuration.

2. The method according to claim 1, further comprising:
determining critical points along the desired movement trajectory at which the mobile manipulator becomes unstable; and
adjusting the center of mass of the mobile manipulator to counteract the determined instability such that the mobile manipulator no longer becomes instable at the critical points.

3. The method according to claim 1, wherein the manipulator base comprises one or more contact elements configured to contact a ground surface upon which the mobile manipulator is movable, wherein the contact elements comprise one or more wheels.

4. The method according to claim 1, wherein determining the desired movement trajectory of the mobile manipulator includes a determination of a movement path of the mobile manipulator and/or a determination of an acceleration of the mobile manipulator.

5. The method according to claim 1, wherein adjusting the center of mass of the mobile manipulator includes an adjustment of the configuration of the manipulator arm to one or more manipulator arm configurations, and wherein the manipulator arm is moved from one manipulator arm configuration to another manipulator arm configuration to adjust the center of mass of the mobile manipulator.

6. The method according to claim 1, wherein the mobile manipulator comprises one or more variable mass elements, and wherein adjusting the center of mass of the mobile manipulator includes an adjustment of the variable mass elements.

7. The method according to claim 6, wherein the variable mass elements include one or more external mass elements that are removably arrangeable at the mobile manipulator and wherein adjusting the center of mass of the mobile manipulator includes adding or removing the external variable mass elements to the mobile manipulator.

8. The method according to claim 6, wherein the variable mass elements include one or more internal mass elements that are non-removably arrangeable at different positions at the mobile manipulator and wherein the step of adjusting the center of mass of the mobile manipulator includes varying the positions of the internal variable mass elements.

9. A mobile manipulator, comprising:
a manipulator base;
at least one manipulator arm; and
a control means adapted to control the mobile manipulator in accordance with a control method, the control method comprising:
determining a current configuration of the mobile manipulator including a manipulator arm configuration and a manipulator base configuration;
determining a desired movement trajectory of the mobile manipulator;
determining a current zero-movement points (ZMP) trajectory, comprising the location of one or more current ZMP of the mobile manipulator, based on the current configuration of the mobile manipulator and the desired movement trajectory;
determining a desired ZMP trajectory of the mobile manipulator, wherein each ZMP is located within a support polygon of the manipulator base; and
adjusting the mobile manipulator such that the current ZMP trajectory corresponds to the desired ZMP trajectory;
wherein adjusting the mobile manipulator comprises adjusting a center of mass of the mobile manipulator including an adjustment of the manipulator arm configuration.

10. The mobile manipulator according to claim 9, wherein the manipulator base comprises one or more contact elements configured to contact a ground surface upon which the mobile manipulator is movable, and wherein the contact elements are wheels.

11. The mobile manipulator according to claim 9, wherein the manipulator arm is adjustable to one or more manipulator arm configurations, wherein the manipulator arm is movable from one manipulator arm configuration to another manipulator arm configuration to adjust the center of mass of the mobile manipulator.

12. The mobile manipulator according to claim 9, wherein the mobile manipulator additionally comprises one or more variable mass elements that are adjustable to adjust the center of mass of the mobile manipulator.

13. The mobile manipulator according to claim 12, wherein the variable mass elements include one or more external mass elements that are removably arrangeable at the mobile manipulator to adjust the center of mass of the mobile manipulator.

14. The mobile manipulator according to claim 12, wherein the variable mass elements include one or more internal mass elements that are non-removably arrangeable at different positions at the mobile manipulator to adjust the center of mass of the mobile manipulator.

15. The mobile manipulator according to claim 9, wherein the mobile manipulator is an autonomous mobile manipulation robot comprising more than two steerable wheels.

16. A computer-readable medium comprising instructions which, when executed by a computer, cause the computer to carry out a method for controlling a mobile manipulator comprising a manipulator base and at least one manipulator arm, the instructions comprising:
instructions for determining a current configuration of the mobile manipulator including a manipulator arm configuration and a manipulator base configuration;
instructions for determining a desired movement trajectory of the mobile manipulator;
instructions for determining a current zero-movement points (ZMP) trajectory, comprising the location of one or more current ZMP of the mobile manipulator, based on the current configuration of the mobile manipulator and the desired movement trajectory;
instructions for determining a desired ZMP trajectory of the mobile manipulator, wherein each ZMP is located within a support polygon of the manipulator base; and
instructions for adjusting the mobile manipulator such that the current ZMP trajectory corresponds to the desired ZMP trajectory;
wherein adjusting the mobile manipulator comprises instructions for adjusting a center of mass of the mobile manipulator including an adjustment of the manipulator arm configuration.
